(19) United States
(12) Patent Application Publication
(10) Pub. No.: US 2005/0078947 A1
(43) Pub. Date: Apr. 14, 2005

(54) Information storage medium for storing subtitle and video mapping information, and method and apparatus for reproducing thereof

(75) Inventors: Hyun-Kwon Chung, Seoul (KR); Seong-iln Moon, Suwon-Si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/901,437

(22) Filed: Jul. 29, 2004

Related U.S. Application Data
(60) Provisional application No. 60/492,331, filed on Aug. 5, 2003.

(30) Foreign Application Priority Data
Sep. 6, 2003 (KR) 2003-62424

(51) Int. Cl. H04N 5/781

(52) U.S. Cl. 386/95; 386/125

(57) ABSTRACT

An information storage medium storing subtitle and video mapping information, and a method and apparatus for reproducing subtitle data correspond to multi-story video data, includes the subtitle and video mapping information regarding a linkage relation between the subtitles and a series of video data, text data information regarding respective subtitle data, and multi-story video data with multiple paths for reproduction. The information storage medium is installed in or separated from a reproducing apparatus so as to reproduce text-based subtitle data to correspond to the multi-story video data.

### CROSS-REFERENCE TO RELATED APPLICATIONS

This application claims the priorities of U.S. Provisional Application No. 60/492,331, filed on Aug. 5, 2003 in the United States Patent and Trademark Office, and Korean Patent Application No. 2003-62424, filed on Sep. 6, 2003 in the Korean Intellectual Property Office, the disclosures of which are incorporated herein in their entirety by reference.

### BACKGROUND OF THE INVENTION

1. Field of the Invention

The present invention relates to fields of reproducing video data and corresponding subtitle data, and more particularly, to an information storage medium storing subtitle and video mapping data information, and an apparatus and method for reproducing video data and corresponding subtitle data from the information storage medium.

2. Description of the Related Art

As shown in FIG. 1, conventional text-based captioning techniques, such as those involving MICROSOFT Synchronized Accessible Media Interchange (SAMI) technology or REALNETWORKS Real-text technology, allow subtitles to be output to correspond to video stream data obtained from a file or via a network, based on video synchronization time. FIG. 1 illustrates a structure of a subtitle data file made to correspond to video data reproduced seamlessly. As shown, the video steam and synchronized subtitle are synchronized by a synchronization time, with the display time for the subtitle being set forth in the code for the subtitle.

However, the subtitle data file does not allow subtitles stored therein to be displayed to correspond to a multi-story video that can be differently reproduced at multiple paths having a same synchronization time via a user interface, using a conventional reproducing apparatus such as a Digital Versatile Disc (DVD) player. As shown in FIG. 2, a conventional text-based subtitle data structure describes only a story A, and cannot selectively describe story B instead of story A. As such, the convention subtitle data structure cannot selectively describe different stories A, B according to a user's need.

### SUMMARY OF THE INVENTION

An aspect of the present invention provides an information storage medium that is installed in or separated from a reproducing apparatus and stores multi-story video data with multiple paths for reproduction and subtitle and video mapping information that specifies a linkage relation between text-based subtitles and a series of video data, and respective text-based subtitle data; and an apparatus and method for reproducing subtitle data corresponding to the video data from the information storage medium.

An aspect of the present invention also provides an information storage medium that stores multi-story video data with multiple paths for reproduction and multi-lingual subtitle indication information that provides multi-lingual text-based subtitles, and an apparatus and method for reproducing the subtitle data corresponding to the video data in a desired language.

An aspect of the present invention also provides an information storage medium that stores multi-story video data recorded to have multiple paths for reproduction in a Digital Versatile Disc (DVD) video structure and text-based multi-lingual subtitle indication information that provides multi-lingual text-based subtitles, and an apparatus and method for reproducing the subtitles corresponding to the video data in a desired language.

An aspect of the present invention also provides an information storage medium that stores multi-story video data recorded to have multiple paths for reproduction in a Blu-ray video structure and text-based multi-lingual subtitle indication information that provides multi-lingual text-based subtitles, and an apparatus and method for reproducing the subtitles corresponding to the video data in a desired language.

According to one aspect of the present invention, there is provided an information storage medium in which multi-story video data is recorded to have multiple paths for reproduction, the information storage medium including subtitle and video mapping information specifying a linkage relation between text-based subtitles and a series of video data corresponding to the multiple paths for reproduction.

According to another aspect of the present invention, there is provided an information storage medium in which multi-story video data is recorded to have multiple paths for reproduction, the information storage medium comprising multi-lingual subtitle indication information supporting multiple languages, subtitle data information, and subtitle and video mapping information specifying a linkage relation between subtitle data and a series of video data according to the multiple paths for reproduction.

According to an aspect of the present invention, the information storage medium further includes an address of a site on the Internet when the multi-lingual subtitle indication information is stored at the site.

According to an aspect of the present invention, the information storage medium further includes information regarding location of a portion of the information storage medium when the multi-lingual subtitle indication information is stored at the portion.

According to yet another aspect of the present invention, there is provided an information storage medium in which multi-story data is recorded to have multiple paths for reproduction and according to a DVD-video structure, comprising subtitle and video mapping information specifying a linkage relation between text-based subtitles and a series of video data according to the multiple paths for reproduction.

According to still another aspect of the present invention, there is provided an apparatus for reproducing multi-story video data recorded to have multiple paths for reproduction from an information storage medium, the apparatus comprising a reader reading one of audio/video (AV) data, text-based subtitle data information, multi-lingual subtitle indication information, and downloaded font data indicated in subtitle and video mapping information from the information storage medium; a decoder decoding the AV data; a subtitle processor processing a language selection file related to subtitle data and the subtitle and video mapping information and performing screen rendering; and a blender combining a moving image output from the decoder and the subtitle data output from the subtitle processor and displaying a result of combination on a display device.

According to an aspect of the present invention, the apparatus further includes a buffer buffering data exchanged among the reader, the decoder, and the subtitle processor, and storing determined font data; and a storage unit storing resident font data stored as a default.

According to an aspect of the present invention, the multi-story video data is recorded based on a structure of DVD-video data.

According to still another aspect of the present invention, there is provided a method of reproducing multi-story video data recorded to have multiple paths for reproduction from an information storage medium, the method comprising determining a subtitle language and detecting a location of subtitle and video mapping information that specifies a linkage relation between text-based subtitles and a series of video data; reading and parsing the subtitle and video mapping information, and reading subtitle data related to video data that is to be reproduced; and reproducing the subtitle data to correspond to the video data reproduced.

According to still another aspect of the present invention, there is provided a method of reproducing multi-story data recorded to have multiple paths for reproduction and according to a DVD-video structure from an information storage medium, the method comprising determining a subtitle language and detecting a location of subtitle and video mapping information regarding a linkage relation between text-based subtitles and a series of video data; reading and parsing the subtitle and video mapping information, and reading subtitle data for video data for a path that is to be reproduced; and reproducing the subtitle data to correspond to the video data displayed on a screen.

According to still another aspect of the present invention, there is provided a method of reproducing multi-story video data recorded to have with multiple paths for reproduction in units of clips from an information storage medium, the method comprising determining a subtitle language and detecting a location of subtitle and video mapping information regarding a linkage relation between text-based subtitles and a series of video data; reading and parsing the subtitle and video mapping information, and reading subtitle data for video data that is to be reproduced; and reproducing the subtitle data to correspond to the video data displayed on a screen.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent and more readily appreciated by describing in detail exemplary embodiments thereof with reference to the accompanying drawings in which:

FIG. 1 illustrates a structure of a conventional subtitle data file that contains subtitles output to correspond to video stream data;

FIG. 2 illustrates a structure of conventional text-based subtitles;

FIG. 3 is a block diagram of a reproducing apparatus according to an embodiment of the present invention;

FIG. 4 is a flowchart illustrating a method of reproducing subtitle data according to an embodiment of the present invention;

FIG. 5 illustrates a structure of text-based subtitles according to an embodiment of the present invention;

FIG. 6 illustrates a structure of subtitle and video mapping data according to an embodiment of the present invention;

FIG. 7 illustrates a structure of multi-lingual subtitle indication information according to an embodiment of the present invention;

FIG. 8 illustrates a structure of subtitle data information according to an embodiment of the present invention;

FIG. 9 illustrates a directory of a Digital Versatile Disc (DVD)-video according to an embodiment of the present invention;

FIGS. 10A and 10B illustrate a logical structure of DVD-video according to an embodiment of the present invention;

FIG. 11 illustrates a cell structure according to an embodiment of the present invention;

FIG. 12 illustrates a structure of subtitle and video mapping information for DVD-video according to an embodiment of the present invention;

FIG. 13 is a table illustrating a subtitle and video mapping information structure according to an embodiment of the present invention;

FIG. 14 illustrates a structure of subtitle data information for DVD-video according to an embodiment of the present invention;

FIG. 15 is a flowchart illustrating a method of reproducing DVD-video according to an embodiment of the present invention;

FIG. 16 illustrates a logical structure of Blu-ray video data according to an embodiment of the present invention;

FIG. 17 illustrates a structure of subtitle and video mapping information for Blu-ray video according to an embodiment of the present invention;

FIG. 18 is a table illustrating subtitle and video mapping information according to an embodiment of the present invention;

FIG. 19 illustrates a structure of subtitle data information for Blu-ray video according to an embodiment of the present invention; and

FIG. 20 is a flowchart illustrating a method of reproducing Blu-ray video according to an embodiment of the present invention.

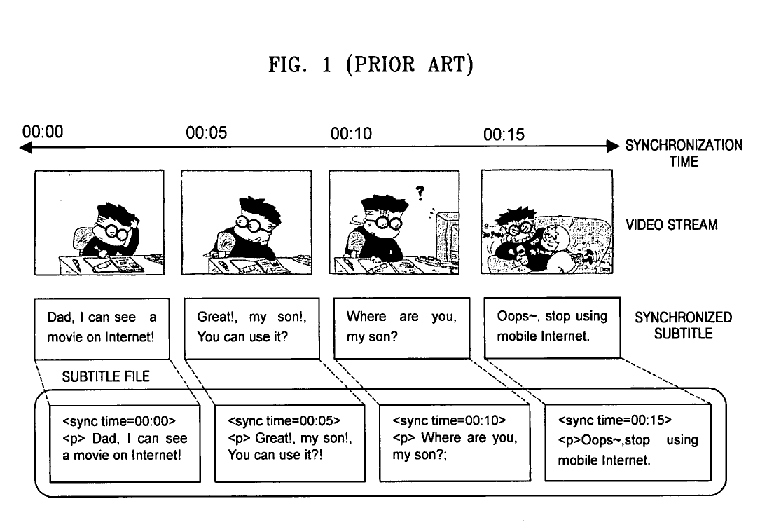

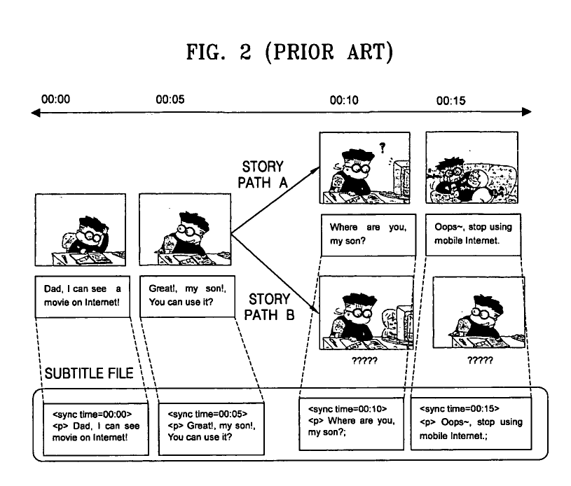

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

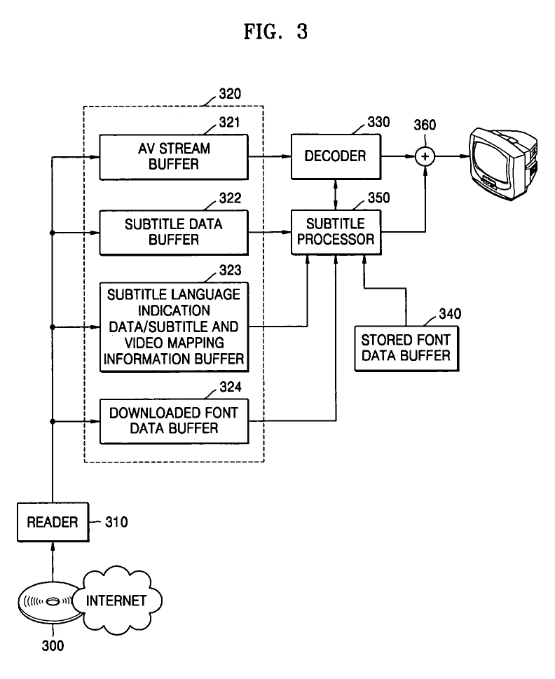

FIG. 3 is a block diagram of a reproducing apparatus according to an embodiment of the present invention. The apparatus of FIG. 3 includes a reader 310 that reads Audio/Video (AV) data, text-based subtitle data information, multi-lingual subtitle indication information, or downloaded font data indicated by subtitle and video mapping information from an information storage medium 300, and a decoder 330 that decodes the AV data (in the case of a Digital Versatile Disc (DVD)). The decoder 330 can be used for reproduction of information recorded on the DVD according to an aspect of the invention. The apparatus further includes a subtitle processor 350 that processes a language selection file related to subtitle data and mapping data for mapping subtitle and video data and performs screen rendering, and a blender 360 that combines a moving image output from the decoder 330 and subtitle data output from the subtitle processor 350 and displays a result of combination on a display device. While described in terms of a reproducing apparatus, it is understood that the apparatus can further record data with respect to an information recording medium according to an aspect of the invention.

Also, the reproducing apparatus further includes a buffering unit 320 that buffers data among the reader 310, the decoder 330, and the subtitle processor 350, and stores selected font data. A stored font data buffer 340 stores resident font data that is predetermined as a default. The shown buffering unit 320 includes an AV stream data buffer 321 to buffer the AV data, a subtitle data buffer 322 to buffer the subtitle data, a subtitle language indication data and/or subtitle and video mapping information buffer 323 to buffer the subtitle language indication data and/or the subtitle and video mapping information, and a downloaded font data buffer 324 to buffer downloaded font data. While shown as separate buffers, it is understood that one or more of the buffers 321, 322, 323, 324, 340 need not be used in all aspects of the invention, and/or can be included in a larger buffer which is logically divided.

For the purposes of the shown embodiment, rendering is understood as every possible processes required to convert text-based subtitle data into graphics data that can be displayed on a display device. For instance, rendering includes all of the processes for detecting a font that matches a character code for a character included in the text data in downloaded font data or resident font data read from an information storage medium, converting the detected font into a graphic, and displaying the graphic on a display device. However, it is understood that the same or equivalent technology can be otherwise described using other terminology.

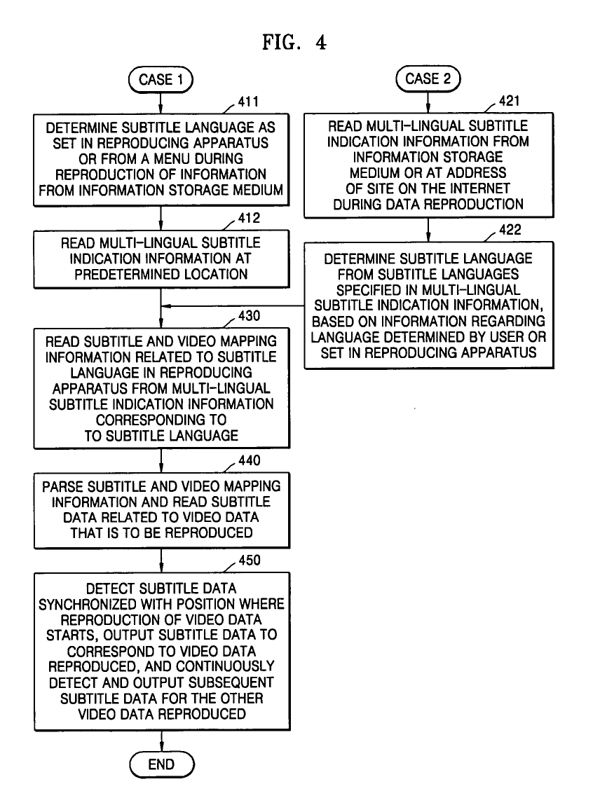

FIG. 4 is a flowchart illustrating a method of reproducing subtitle data according to an embodiment of the present invention. The shown method includes selecting a subtitle language and detecting a location of video mapping data (operations 411 and 412, or operations 421 and 422), reading and parsing video mapping data to read related subtitle data in a reproducing apparatus (operations 430 and 440), and reproducing the subtitle data to correspond to video data (operation 450).

Referring to FIG. 4, a subtitle language may be set as instructed in case 1 or 2. In case 1, the subtitle language is determined as set in the reproducing apparatus or selected from a menu stored in an information storage medium by a user during reproduction of a movie (operation 411). Next, multi-lingual subtitle indication information is read at a predetermined position to determine a final subtitle language (operation 412). In case 2, multi-lingual subtitle indication information is read from an information storage medium or at an address of a site on the Internet (such as an address indicated using a Uniform Resource Identifier (URI)), where the address is detected by the reproducing apparatus during data reproduction (operation 421). Next, the subtitle language is selected from subtitle languages specified in the multi-lingual subtitle indication information, based on information regarding the language determined by the user or set in the reproducing apparatus (operation 422).

Thereafter, subtitle and video mapping information related to the subtitle language set in case 1 or 2 is read in the reproducing apparatus from multi-lingual subtitle indication information (operation 430). Next, the subtitle and video mapping information is parsed to read subtitle data related to video data that is to be reproduced (operation 440). Next, subtitle data is detected and synchronized with a position where reproduction of the video data starts. The subtitle data is output to correspond to the reproduced video data, and the subsequent subtitle data are continuously detected and output to correspond to the video data being reproduced (operation 450). As such, the output subtitle data is linked to a structure of the video data so as to allow the subtitle to be output according to a corresponding portion of the video data, thereby allowing reproduction of different story paths and/or scenes of the video data along with the corresponding subtitles.

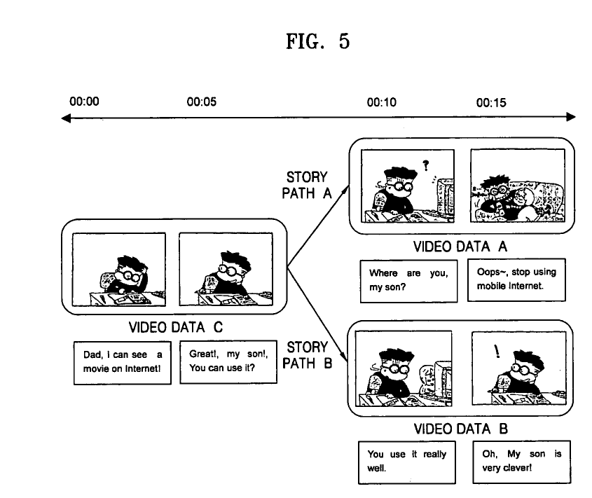

FIG. 5 illustrates a structure of text-based subtitles according to an embodiment of the present invention. Referring to FIG. 5, an information storage medium stores multi-story video data recorded to have multiple paths A and B for reproduction. The information storage medium further stores subtitle and video mapping information regarding a linkage relation between text-based subtitles and a series of video data A, B, C, and subtitle data information regarding respective subtitles. The information storage medium is installed in or separated from a reproducing apparatus. The subtitle and video mapping information and the subtitle data information are read and reproduced by the reproducing apparatus capable of reproducing multi-story video data. Here, the information storage medium separated from the reproducing apparatus may be a memory card or the Internet. As shown, after reading video data C, a choice between story paths A and B is made at synchronization time 00:10. Based upon a selection, different subtitles are displayed at a same synchronization time based on the selected one of the video data A and B so as to allow the subtitle to reflect the different scenes reproduced in each path A, B.

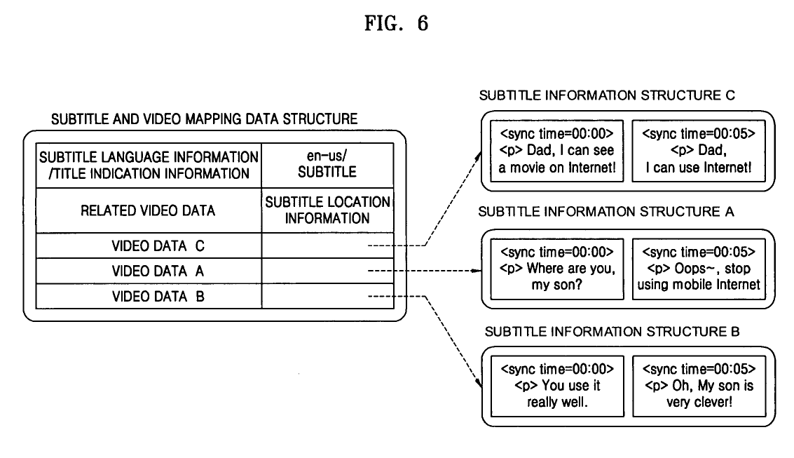

FIG. 6 illustrates a structure of subtitle and video mapping information regarding a linkage relation between text-based subtitles and a series of video data related to multi-story video data such as that shown in FIG. 5, recorded to have multiple paths A and B for reproduction. The subtitle and video mapping information contains subtitle language information regarding subtitle languages, title indication information regarding titles of subtitles displayed on a screen, and subtitle location indication information regarding the location of subtitle data specified in the subtitle and video mapping information. As shown, the indicated language is English (US). The title indication information is for video data C, A, B, and the subtitle information structures C, A, B indicate the subtitle and time id display during reproduction of corresponding video data C, A, B. As such, during reproduction of video data C, the mapping data structure indicates to the reproducing apparatus that the subtitle information structure C is reproduced. During reproduction of video data B, the mapping data structure indicates to the reproducing apparatus that the subtitle information structure B is reproduced. During reproduction of video data A, the mapping data structure indicates to the reproducing apparatus that the subtitle information structure A is reproduced. As such, even though video data B and A are scenes to be reproduced at the same synchronization time, the mapping data structure allows the apparatus to produce a corresponding subtitle reflecting each distinct item of video data.

FIG. 7 illustrates a structure of multi-lingual subtitle indication information that specifies subtitle and video mapping information according to languages to provide multi-lingual text-based subtitles. Referring to FIG. 7, multi-lingual subtitle indication information supporting multiple languages (shown as English, Korean and Japanese), and the subtitle and video mapping information that specifies a linkage relation between text-based subtitles and a series of multi-story video data with multiple paths for reproduction, are combined and recorded on an information storage medium. If the multi-lingual subtitle indication information is stored at a site on the Internet, the address of the site is stored in the information storage medium. If the multi-lingual subtitle indication information is stored in a portion of the information storage medium, information regarding the portion is stored in the information storage medium.

The multi-lingual subtitle indication information includes language indication information regarding a language in which the subtitle and video mapping information is recorded, title indication information regarding titles of the subtitle and video mapping information displayed on a screen, and subtitle and video mapping information indication information. A structure of the subtitle and video mapping information is as illustrated in FIG. 6.

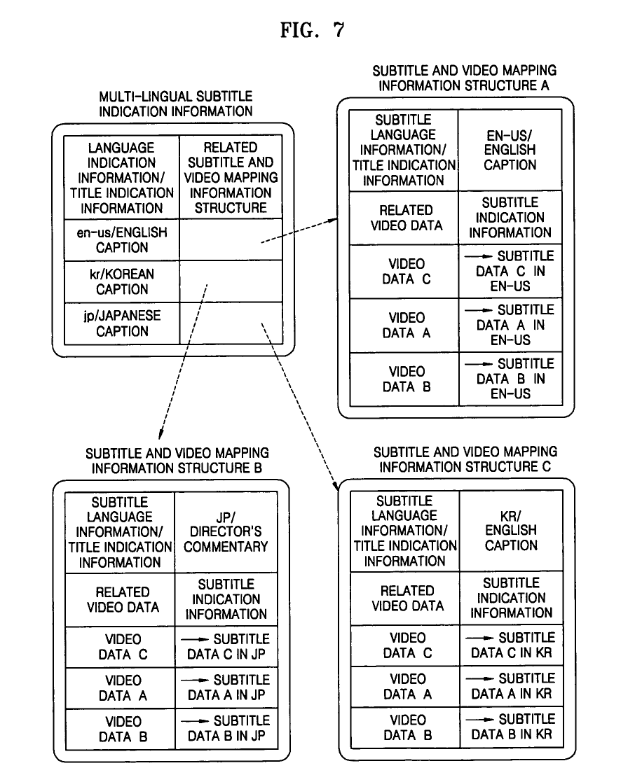

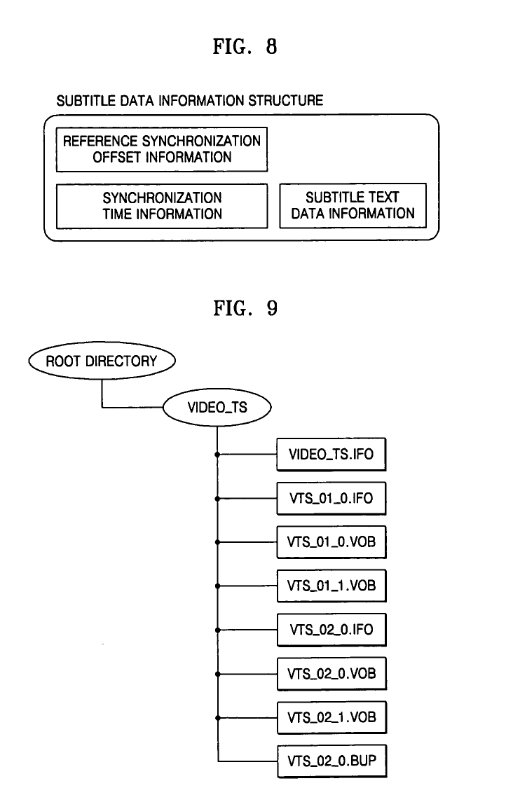

FIG. 8 illustrates a structure of subtitle data information such as that shown in FIG. 6. Referring to FIG. 8, the subtitle data information includes reference synchronization offset information regarding an absolute reference starting point of time when subtitles are displayed; synchronization time information that indicates subtitle synchronization time for subtitle synchronization (i.e., information regarding time elapsed from a reference synchronization offset); and text data information regarding the subtitles.

A structure of subtitle and video mapping information reproduced by a DVD-Video player and a method of reproducing the same will now be described.

FIG. 9 illustrates a directory structure of DVD-video according to an embodiment of the present invention. Referring to FIG. 9, a root directory includes a video directory VIDEO_TS in which the AV data is stored. The AV data and reproduction control information (navigation data) are recorded in the video directory VIDEO_TS. The reproduction control information includes information for decoding the AV data. More specifically, the video directory VIDEO_TS includes information VIDEO_TS.IFO containing header information regarding all video titles. Next, the video directory VIDEO_TS sequentially includes information VTS_{—}01_{—}0.IFO containing header information regarding a first video title, AV data VTS_{—}01_{—}0.VOB and VTS_{—}01_{—}1.VOB constituting the first video title, AV data VTS_{—}02_{—}0.IFO containing header information regarding a second video title, AV data VTS_{—}02_{—}0.VOB and VTS_{—}02_{—}1.VOB constituting the second video title, and a backup file VTS_{—}02_{—}0.BUP (see “DVD-Video for Read Only Memory Disc 1.0”, the disclosure of which is incorporated by reference, that is a DVD-video standard for more details).

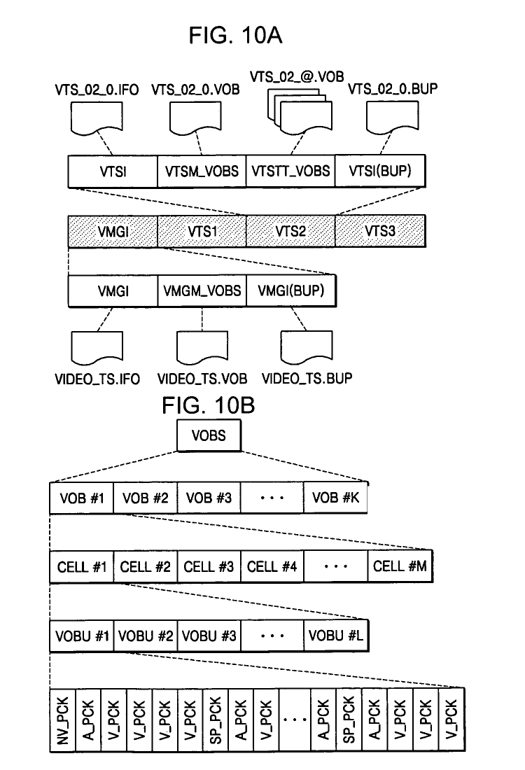

FIGS. 10A and 10B illustrate a logical structure of DVD-video. The DVD-video of FIG. 10A includes a Video ManaGer (VMG) that contains header information regarding all video titles and n video title sets VTS1, VTS2, . . . , VTSn. The VMG includes Video ManaGer Information (VMGI) containing control data, Video OBject Set (VOBS) linked to the VMG, and backup data for the VMGI. The VOBS is not required to be contained in the VMG.

Each VTS includes Video Title Set Information (VTSI) containing the header information, a VOBS for displaying a menu screen, a VOBS that includes video titles, and backup data for the VTSI. The inclusion of the VOBS for displaying a menu screen is optional. Each VOBS that has video data referred to by the VTS includes K video objects (VOBs) VOB #1, VOB #2, . . . , VOB #K.

As shown in FIG. 10B, each VOB includes M cells cell #1, cell #2, . . . , cell #M. Each cell includes a plurality of Video OBject Units (VOBUs). Each VOBU includes a navigation pack NV_PCK available for reproducing or searching for a VOBU selected from VOBUs 1 through L. Also, an audio pack A_PCK, a video pack V_PCK, and a sub-picture pack SP_PCK that constitute a VOBU are multiplexed and recorded in each VOBU. All of these packs are encoded as AV object data according to the Motion Picture Expert Group (MPEG) ISO-13818 in the shown embodiment.

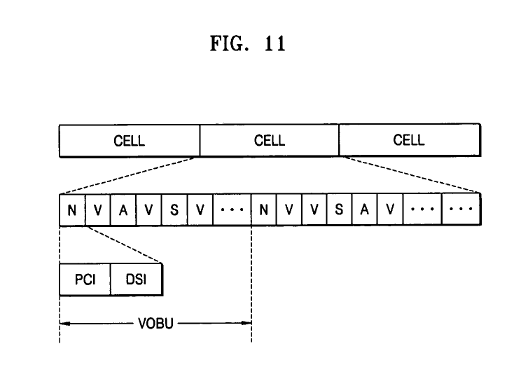

As shown in FIG. 11, the navigation pack NV PCK includes Presentation Control Information (PCI) and Data Search Information (DSI). The DSI is navigation data that allows a search for or seamless reproduction of VOBUs and is updated for every VOBU. The DSI contains information VOBU_VOB_IDN that specifies the identification (ID) number VOB_ID of a related VOB to which a cell having the VOBU belongs. Also, the DSI contains information regarding the ID number VOBU_C_IDN of the cell that includes the VOBU. Also, the DSI includes information C_ELTM that specifies time required to reproduce from a first video frame of the cell with the VOBU to a first video frame of the VOBU.

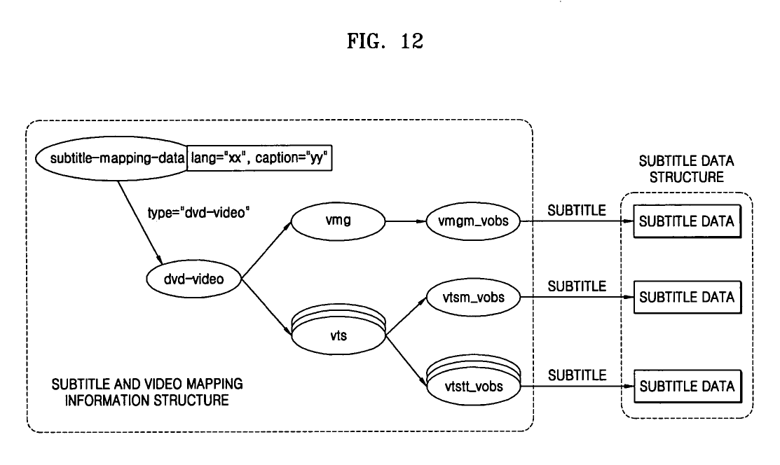

FIG. 12 illustrates subtitle and video mapping information regarding DVD video such as that shown in FIGS. 9 through 11. Referring to FIG. 12, the subtitle and video mapping information includes indication information that indicates a VOBS linked to at least one subtitle, and the indication information specifies a VOB linked to the VOBS. The subtitle and video mapping information includes language information regarding the language in which the subtitle is recorded, and title indication information regarding the title of the subtitle that is to be displayed on a screen. However, it is understood that the indication information can link to other structures within the VTS which correspond to indicate a relationship between a specific subtitle and a path of the multistory video data.

Multi-lingual subtitle indication information may be added to the subtitle and video mapping information and is recorded in an information storage medium. When the multi-lingual subtitle indication information is recorded in a site on the Internet, the address of the site is stored in the information storage medium. When the multi-lingual subtitle indication information is stored in a portion of the information storage medium, information regarding the location of the portion is stored therein.

The subtitle and video mapping information regarding the DVD-video may be described in an extensible Markup Language (XML) as follows:

```
<subtitle-mapping-data type=“dvd-video” lang=“en-us” caption=
“English caption”>
<dvd-video>
<vmg>
<vmgm_vobs>
    <subtitle vob_idn=“1” href=“file://english_vmgm.text” />
</vmgm_vobs>
</vmg>
<vts idn=“1”>
<vtsm_vobs>
    <subtitle=vob_idn=“1” href=“file://english_vtsm.text” />
</vtsm_vobs>
<vtstt_vobs>
    <subtitle_vob idn=“1-9” href=“ file://english_tt1vob1.text” />
    <subtitle_vob idn=“10-49” href=“ file://english_tt1vob10.text” />
    <subtitle_vob idn=“50-100” href=“ file://english_tt1vob50.text” />
</vtstt_vobs>
</vts>
</dvd-video>
</subtitle-mapping-data>
```

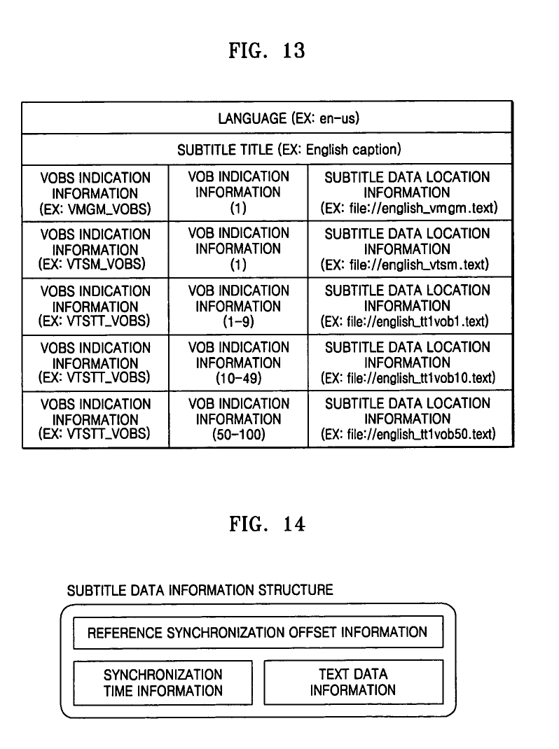

A table describing subtitle and video mapping information regarding DVD-video according to an embodiment of the present invention is illustrated in FIG. 13. As shown, the mapping information is for English (US), with the subtitle title being an English caption. In the first VOBS indication information, the indication information is for a VMGM_VOBs, the VOB indication information is for VOB(1), and the corresponding subtitle data location is in a file entitled “English_vmgm.text.” In the second VOBS indication information, the indication information is for a VTSM_VOBs, the VOB indication information is for VOB(1), and the corresponding subtitle data location is in a file entitled “English_vstm.text.” In the third VOBS indication information, the indication information is for a VTSTT_VOBs, the VOB indication information is for VOB(1-9), and the corresponding subtitle data location is in a file entitled “English_tt1vob1.text.” In the fourth VOBS indication information, the indication information is for a VTSTT_VOBs, the VOB indication information is for VOB(10-49), and the corresponding subtitle data location is in a file entitled “English_tt1vob10.text.” In the fifth VOBS indication information, the indication information is for a VTSTT_VOBs, the VOB indication information is for VOB(50-100), and the corresponding subtitle data location is in a file entitled “English_tt1vob50.text.” However, it is understood that other types of information can be indicated and that the links and text files can be otherwise indicated according to aspects of the invention.

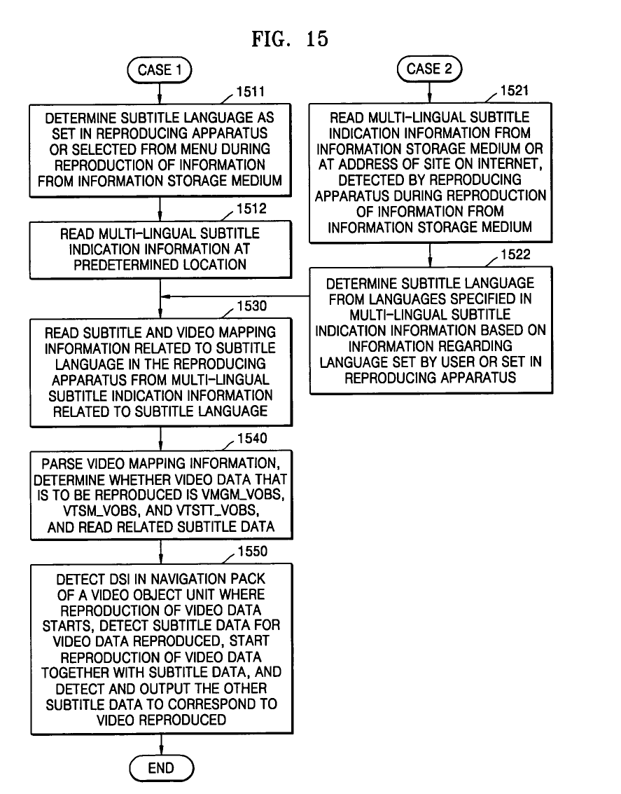

FIG. 14 illustrates a structure of text-based subtitle data information regarding DVD-video according to an embodiment of the present invention. Referring to FIG. 14, the subtitle data information contains reference synchronization offset information specifying a starting point of time when subtitles are output using at least one value VOB_IDN and at least one value CELL_IDN, synchronization time information that indicates time elapsed from a reference synchronization offset using a point of time when reproduction of a reference cell starts, and text data information regarding the subtitles.

Examples of subtitle data based on the structure of the text-based subtitle data information shown in FIG. 14 are as follows in examples 1 through 3.

### EXAMPLE 1

When a VOB identification value vob_id ranges from 1 to 5, a value of a cell identification value cell_id is 1, and sync time is computed based on the value vob_id=1 and the value cell_id=1, subtitle data information is as follows:

<sync time=“0” value=“vob_idn=1-5,cell_idn=1” />
<p>Dad, I can see a movie on Internet!</p>
<sync time=“5000” value=“vob_idn=1-5,cell_idn=1”>

### EXAMPLE 2

When a VOB identification value vob_id is 6, a cell identification value cell_id ranges from 1 to 5, and synchronization time is computed based on the value vob_id=6 and the value cell_id=1, subtitle data information is as follows:

```
<sync time=“0” value=“vob_idn=6,cell_idn=1-5” />
    <p>Where are you, my son?</p>
<sync time=“5000” value=“vob_idn=6,cell_idn=1-5”>
    <p>Oops!, stop using mobile Internet.</p>
```

### EXAMPLE 3

When synchronization time is computed based on a VOB identification value vob_id is 7 and a cell identification value cell_id is 1, subtitle data information is as follows:

```
<sync time=“0” value=“vob_idn=7,cell_idn=1” />
    <p>You can use it really well</p>
<sync time=“5000” value=“vob_idn=7,cell_idn=1”>
    <p>Oh!, My son is very clever!</p>
```

To reproduce subtitle data corresponding to DVD-video data, information regarding a text output as a start of the subtitle data is obtained using information VOBU_VOB_IDN, VOBU_C_IDN, and C_ELTM of DSI included in a navigation pack NV PCK of the video data.

FIG. 15 is a flowchart illustrating a method of reproducing subtitle data for DVD-video data according to an embodiment of the present invention. The method of FIG. 15 includes selecting a subtitle language and detecting a location of subtitle and video mapping data (operations 1511 and 1512 or operations 1521 and 1522), reading and parsing the subtitle and video mapping data to read related subtitle data in a reproducing apparatus (operations 1530 and 1540), and reproducing the subtitle data to correspond to video data (operation 1550).

According to this method, a subtitle language is selected as suggested in Case 1 or 2. Specifically, in Case 1, a language is determined as set in the reproducing apparatus or selected by a user from a menu recorded in an information storage medium during reproduction of a movie stored therein (operation 1511). Next, multi-lingual subtitle indication information is read at a predetermined location and a final subtitle language is selected based on the read information (operation 1512). In Case 2, the multi-lingual subtitle indication information is read from the information storage medium or at an address of a site on the Internet such as a Uniform Resource Identifier (URI), the address being detected by the reproducing apparatus during reproduction of the movie from the information storage medium (operation 1521). Next, the subtitle language is selected from languages specified in the multi-lingual subtitle indication information based on information regarding a language set by the user or set in the reproducing apparatus (operation 1522).

Next, subtitle and video mapping information regarding the subtitle language is read in the reproducing apparatus from multi-lingual subtitle indication information related to the subtitle language selected as instructed in Case 1 or 2 (operation 1530). The read video mapping information is parsed to determine whether video data that is to be reproduced is VMGM_VOBS, VTSM_VOBS, or VTSTT_VOBS as described in FIG. 12, and related subtitle data is read (operation 1540). A DSI in a navigation pack NV PCK of a VOBU shown in FIG. 11, where reproduction of the video data will start, is detected to obtain subtitle data for video output when reproducing the video data, reproduction of the video data together with the subtitle data starts, and the subsequent subtitle data are detected and output to correspond to the video reproduced (operation 1550).

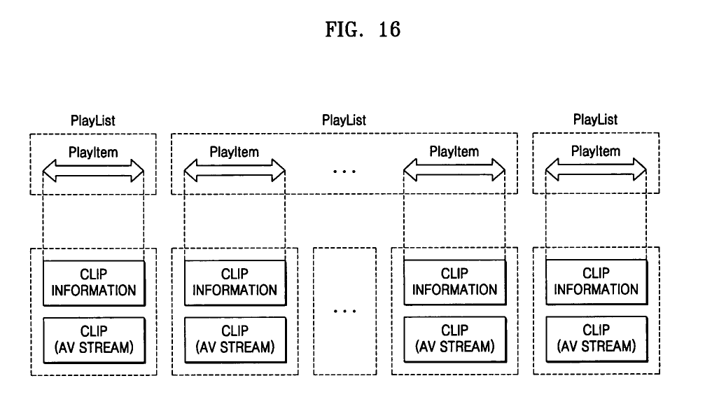

A structure of subtitles and subtitle and video mapping information related to Blu-ray video, and a method of reproducing subtitle data for the Blu-ray video, according to an aspect of the present invention, will now be described. FIG. 16 illustrates a logical structure of Blue-ray video according to an embodiment of the present invention. Referring to FIG. 16, a clip is used as a record unit of video object data, and a PlayList and a PlayItem are used as reproduction units thereof.

Blu-ray video data includes AV streams recorded in units of clips. In general, the clips are recorded continuously in a portion of an information storage medium and an AV stream is compressed and recorded to reduce its size. Thus, information regarding the characteristics of the video object data is required to reproduce the compressed AV stream. For this reason, each clip is recorded together with clip information. The clip information specifies AV attributes of each clip and includes an entry point map describing the locations of entry points that allow random access in predetermined units. In the case of an MPEG standard that is often used to compress moving images, each of the entry points indicates the location of an intra picture where an intra image is compressed and the entry point map is mainly used for a time search that detects the position of data in a time zone a predetermined time after start of data reproduction. However, it is understood that other mechanisms can be used to compress AV data.

A PlayList is a basic reproduction unit. A plurality of PlayLists are recorded in a Blu-ray disc. A PlayList is linked to a plurality of PlayItems. A PlayItem corresponds to a portion of a clip, and more particularly, the play item indicates starting and ending points of time when a clip is reproduced. Therefore, the clip information allows a desired portion of a clip to be easily detected.

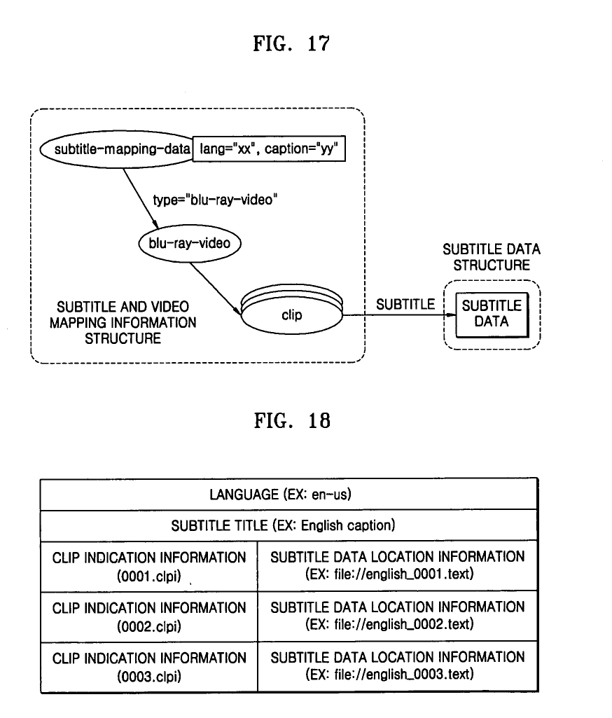

A structure of subtitle and video mapping information of text-based subtitles regarding Blu-ray video is illustrated in FIGS. 17 and 18. FIG. 17 illustrates the relationship between subtitle and video mapping information allowing subtitles to be mapped to Blu-ray video, and subtitle data, according to an embodiment of the present invention. Referring to FIG. 17, when the subtitle and video mapping information is recorded on an information storage medium based on a logical structure of the Blu-ray video, the subtitle and video mapping information contains indication information that indicates subtitle data linked to clips. The subtitle and video mapping information also specifies a language of the subtitle data and a title of the subtitle data displayed on a screen.

Multi-lingual subtitle indication information may be added to the subtitle and video mapping information. When the multi-lingual subtitle indication information is obtained from a site on the Internet, the address of the site is stored in the information storage medium. If the multi-lingual subtitle indication information is stored in a portion of the information storage medium, information regarding the portion is recorded in the information storage medium.

Code of the subtitle and video mapping information based on the logical structure of Blu-ray may be described in XML, as follows:

```
<subtitle-mapping-data type=“blu-ray-video” lang=“en-us” caption=
“English caption”>
<blu-ray-video>
    <subtitle clip_idn=“0001.clpi” href=“english_0001.text” />
    <subtitle clip_idn=“0002.clpi” href=“english_0002.text” />
    <subtitle clip_idn=“0003.clpi” href=“english_0003.text” />
</blu-ray-video>
</subtitle-mapping-data>
```

FIG. 18 is a table illustrating a structure of subtitle and video data mapping information regarding Blu-ray video according to an embodiment of the present invention. As shown, the mapping information is for English (US), with the subtitle title being an English caption. In the first Clip indication information, the indication information is for clip 0001, and the corresponding subtitle data location is in a file entitled “English_{—}0001.text.” In the second Clip indication information, the indication information is for clip 00021, and the corresponding subtitle data location is in a file entitled “English_{—}0002.text.” In the third Clip indication information, the indication information is for clip 0003, and the corresponding subtitle data location is in a file entitled “English_{—}0003.text.” As such, the mapping information indicates a link between specific clips and the corresponding subtitles. However, it is understood that the mapping information can be linked to other elements within the playlists and/or other structures within the Blu-ray video.

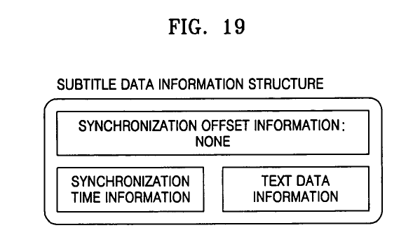

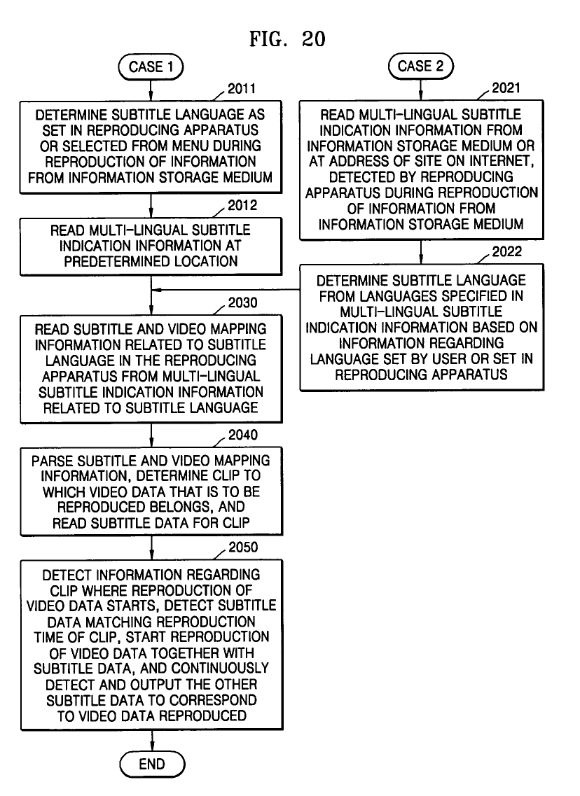

FIG. 19 illustrates a structure of subtitle data information related to Blu-ray video. Referring to FIG. 19, the subtitle data information does not contain synchronization information, and contains synchronization time information that indicates relative time regarding a starting point of time when a clip is reproduced, and text data information regarding subtitles.

Examples of subtitle data based on the subtitle data information shown in FIG. 19, according to the present invention, will now be described. However, it is understood that it is possible to include offset information according to aspects of the invention.

### EXAMPLE 1

```
<sync time=“0”/>
    <p>Dad, I can see a movie on Internet!</p>
<sync time=“5000”>
    <p>Great!, my son!, You can use it?</p>
Example 2:
<sync time=“0”/>
    <p>Dad, I can see a movie on Internet!</p>
<sync time=“5000”/>
    <p>Great!, my son!, You can use it?</p>
```

As shown, the subtitle data is recorded using a reference synchronization offset as a starting point of a clip for outputting subtitles. The subtitle data contains information that indicates a point of time when subtitles are output using time elapsed from the reference synchronization offset. The multi-lingual subtitle indication information, the subtitle and video mapping information, and the subtitle data information may be separately recorded in units of files or units of information storage units, or may be combined and recorded within a file or an information storage unit.

The subtitle data regarding the Blu-ray video is reproduced by detecting an entry point map specifying the location of an entry point for data reproduction, checking in reproduction time described in the entry point map, and outputting subtitles matching the synchronization time information included in the subtitle data information.

FIG. 20 is a flowchart illustrating a method of reproducing subtitle data for Blu-ray video according to an embodiment of the present invention. The method includes selecting a subtitle language and detecting the location of subtitle and video mapping information (operations 2011 and 2012 or operations 2021 and 2022), reading and parsing the subtitle and video mapping information to read related subtitle data in a reproducing apparatus (operations 2030 and 2040), and reproducing the subtitle data to correspond to video data that is reproduced on a screen (operation 2050).

Referring to FIG. 20, the subtitle language is selected as suggested in Case 1 or 2. Specifically, in Case 1, a subtitle language is determined as set in the reproducing apparatus or selected by a user from a menu stored in an information storage medium during reproduction of a movie stored therein (operation 2011). Next, multi-lingual subtitle indication information is read at a predetermined location and a final subtitle language is selected based on the read multi-lingual subtitle indication information (operation 2012). In Case 2, the multi-lingual subtitle indication information is read from the information storage medium or at the address of a site on the Internet, such as an Uniform Resource Identifier (URI), the address detected by the reproducing apparatus during reproduction of information from the information storage medium (operation 2021). Next, the subtitle language is finally selected from languages specified in the multi-lingual subtitle indication information based information regarding the language set by the user or set in the reproducing apparatus (operation 2022).

Next, subtitle and video mapping information of the subtitle language is read in the reproducing apparatus from multi-lingual subtitle indication information corresponding to the subtitle language as instructed in Case 1 or 2 (operation 2030). Next, the read subtitle and video mapping information is parsed to determine a clip to which the video data that is to be reproduced belongs, and subtitle data for the clip is read (operation 2040). Next, information regarding a clip where reproduction of the video data starts is detected, subtitle data matching reproduction time of the clip is detected, reproduction of the video data together with the subtitle data starts, and the subsequent subtitle data are continuously detected and output to correspond to the video data reproduced (operation 2050).

Aspects of the present invention can be embodied as a computer readable code stored in at least one computer readable medium for use in one or more computers. Here, the computer readable medium may be any recording apparatus capable of storing data that can be read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

Moreover, while described in terms of multi-story video data, it is understood that the video data need not have stories which are alternately displayed at a common synchronization time, but can also be used to display scenes having non-common synchronization times so as to allow reproduction of requested scenes taken out of order. Additionally, while shown as being text based, it is understood that the subtitles can include images and/or audio according to aspects of the invention.

As described above, according to aspects of the present invention, subtitle and video mapping information regarding a linkage relation between the subtitles and a series of video data, and text data information regarding respective subtitle data are further stored in an information storage medium storing multi-story video data with multiple paths for reproduction, the information storage medium being installed in or separated from a reproducing apparatus. Accordingly, it is possible to reproduce text-based subtitle data to correspond to the multi-story video data. Additionally, since a linkage relationship is established between the subtitle and a logical structure of the video data, the subtitles are displayed regardless of an order in which the video elements of the video data are displayed to make it possible to reproduce subtitle data with multi-story and/or multi-scene video data.

Also, an aspects of the present invention provides multi-lingual subtitle indication information that indicates subtitle and video mapping information according to languages, thereby enabling reproduction of subtitles in a desired language.

Further, an aspect of the present invention allows reproduction of multi-story video such as DVD video and Blu-ray video.

While this invention has been particularly shown and described with reference to exemplary embodiments thereof, it will be understood by those skilled in the art that various changes in form and details may be made therein without departing from the spirit and scope of the invention as defined by the appended claims and equivalents thereof.

1. An information storage medium in which multi-story video data is recorded to have multiple paths for reproduction by a recording and/or reproducing apparatus, comprising subtitle and video mapping information specifying a linkage relation between text-based subtitles and a series of video data corresponding to the multiple paths for reproduction by the apparatus.

2. The information storage medium of claim 1, wherein the subtitle and video mapping information comprises subtitle language information regarding subtitle languages.

3. The information storage medium of claim 1, wherein the subtitle and video mapping information comprises title indication information regarding titles of subtitles displayed on a screen.

4. The information storage medium of claim 1, wherein the subtitle and video mapping information is retrieved by the apparatus using subtitle location indication information which indicates a location of subtitle data and the subtitle and video mapping information relative to the information storage medium.

5. The information storage medium of claim 4, further comprising an address of a site on the Internet when the subtitle location indication information is stored at the site.

6. The information storage medium of claim 4, further comprising information regarding a location of a portion of the information storage medium when the subtitle location indication information is stored in the portion.

7. The information storage medium of claim 1, wherein the subtitle and video mapping information comprises text-based subtitle data information related to the video data.

8. The information storage medium of claim 5, wherein the subtitle data information further comprises at least one reference synchronization offset information for use by the apparatus in displaying related subtitle text.

9. The information storage medium of claim 8, wherein the subtitle data information further comprises synchronization time information for use by the apparatus in synchronizing the subtitles using information regarding time elapsed from the reference synchronization offset information for displaying related subtitle text.

10. The information storage medium of claim 7, wherein the subtitle and video mapping information and the subtitle data information are separately recorded in units of files or units of information storage units.

11. An information storage medium in which multi-story video data is recorded to have multiple paths for reproduction by a recording and/or reproducing apparatus, comprising:
multi-lingual subtitle indication information supporting multiple languages;
subtitle data information including subtitle data; and
subtitle and video mapping information specifying a linkage relation between the subtitle data for each of the multiple languages and a series of video data according to the multiple paths for reproduction by the apparatus.

12. The information storage medium of claim 11, wherein the apparatus retrieves the multi-lingual subtitle indication information using an address of a site on the Internet when the multi-lingual subtitle indication information is stored at the site.

13. The information storage medium of claim 11, further comprising information regarding a location of a portion of the information storage medium when the multi-lingual subtitle indication information is stored in the portion.

14. The information storage medium of claim 11, wherein the multi-lingual subtitle indication information comprises language indication information regarding a language of the subtitle and video mapping information.

15. The information storage medium of claim 11, wherein the multi-lingual subtitle indication information comprises title indication information regarding a title of the subtitle and video mapping information displayed on a screen.

16. The information storage medium of claim 11, wherein the multi-lingual subtitle indication information comprises indication information indicating the subtitle and video mapping information.

17. The information storage medium of claim 11, wherein the multi-lingual subtitle indication information comprises subtitle language information regarding subtitle languages, title indication information regarding titles of subtitles displayed on the screen, and subtitle location indication information regarding location of subtitle data.

18. The information storage medium of claim 11, wherein subtitle data information further comprises at least one reference synchronization offset information for use by the apparatus in displaying related subtitle text.

19. The information storage medium of claim 11, wherein the subtitle data information further comprises at least one synchronization time information for use by the apparatus in displaying related subtitle text.

20. The information storage medium of claim 19, wherein the subtitle data information further comprises synchronization time information for use by the apparatus synchronizing the subtitles using information regarding time elapsed from a reference synchronization offset for use by the apparatus in displaying related subtitle text.

21. The information storage medium of claim 11, wherein the multi-lingual subtitle indication information, the subtitle data information, and the subtitle and video mapping information are separately recorded in units of files or units of information storage units.

22. The information storage medium of claim 11, wherein the multi-lingual subtitle indication information, the subtitle data information, and the subtitle and video mapping information are combined and recorded in the same area.

23. An information storage medium in which multi-story data is recorded to have multiple paths for reproduction and according to a DVD-video structure, comprising subtitle and video mapping information specifying to a recording and/or reproducing apparatus a linkage relation between text-based subtitles and a series of video data according to the multiple paths for reproduction by the apparatus.

24. The information storage medium of claim 23, wherein the subtitle and video mapping information comprises at least one indication information indicating a video object set linked to subtitle.

25. The information storage medium of claim 24, wherein the indication information comprises indication information indicating a video object data of the video object set to which the subtitle is linked.

26. The information storage medium of claim 25, wherein the video object set is linked to one of video manager information for a menu, a video title set for a menu, and a video title set for a title.

27. The information storage medium of claim 24, wherein the apparatus retrieves the indication information from an address of a site on the Internet when the indication information is stored at the site.

28. The information storage medium of claim 24, further comprising information regarding location of a portion of the information storage medium when the indication information is stored in the portion.

29. The information storage medium of claim 23, wherein the subtitle and video mapping information comprises subtitle language information regarding subtitle languages.

30. The information storage medium of claim 23, wherein the subtitle and video mapping information comprises title indication information regarding titles of subtitles displayed on a screen.

31. The information storage medium of claim 23, wherein the subtitle and video mapping information comprises subtitle data information related to the video data.

32. The information storage medium of claim 31, wherein the subtitle data information further comprises reference synchronization offset information specifying a starting point of time when subtitles are displayed by the apparatus, using identification information regarding at least one video object and/or a cell.

33. The information storage medium of claim 31, wherein the subtitle data information further comprises synchronization time information specifying identification of a reference video object and/or a relative time regarding a start point of a reference cell.

34. The information storage medium of claim 31, wherein the subtitle and video mapping information and the subtitle data information are separately recorded in units of files or units of information storage units.

35. An information storage medium in which multi-story data is recorded to have multiple paths for reproduction by a recording and/or reproducing apparatus according to a DVD-video structure, comprising:
multi-lingual subtitle indication information supporting multiple languages;
subtitle data information including text based subtitle data; and
subtitle and video mapping information indicating to the apparatus a linkage relation between the text-based subtitles for each of the multiple languages and a series of video data based on the multi-story DVD-video.

36. The information storage medium of claim 35, further comprising an address of a site on the Internet when the multi-lingual subtitle indication information is stored at the site.

37. The information storage medium of claim 35, further comprising information regarding location of a portion of the information storage medium when the multi-lingual subtitle indication information is stored in the portion.

38. The information storage medium of claim 35, wherein the multi-lingual subtitle indication information comprises indication information indicating to the apparatus a video object set linked to at least one subtitle.

39. The information storage medium of claim 38, wherein the multi-lingual subtitle indication information comprises indication information indicating to the apparatus a video object of the video object set to which the at least one subtitle is linked.

40. The information storage medium of claim 39, wherein the video object set is linked to one of video manager information for a menu, a video title set for a menu, and a video title set for a title.

41. The information storage medium of claim 35, wherein the multi-lingual subtitle indication information comprises indication information regarding a language of the subtitle and video mapping information.

42. The information storage medium of claim 35, wherein the multi-lingual subtitle indication information comprises title indication information regarding titles of the subtitle and video mapping information displayed on a screen.

43. The information storage medium of claim 35, wherein the subtitle and video mapping information comprises subtitle language information regarding subtitle languages, title indication information regarding titles of subtitles displayed on the screen, and subtitle location indication information regarding location of subtitle data.

44. The information storage medium of claim 35, wherein the subtitle data information further comprises reference synchronization offset information specifying a starting point of time when subtitles are displayed, using identification information regarding at least one video object and/or cell.

45. The information storage medium of claim 35, wherein the subtitle data information further comprises synchronization time information specifying identification of a reference video object and/or a relative time regarding a start point of a reference cell.

46. The information storage medium of claim 35, wherein multi-lingual subtitle indication information, the subtitle data information, and the subtitle and video mapping information are separately recorded in units of files or units of information storage units.

47. The information storage medium of claim 35, wherein multi-lingual subtitle indication information, the subtitle data information, and the subtitle and video mapping information are combined and recorded in the same area.

48. An information storage medium in which multi-story data is recorded to have multiple paths for reproduction by a recording and/or reproducing apparatus in units of clips according to a Blu-ray video structure, comprising subtitle and video mapping information specifying a linkage relation between text-based subtitles and a series of video data according to the multiple paths for reproduction by the apparatus.

49. The information storage medium of claim 48, wherein the subtitle and video mapping information comprises indication information indicating to the apparatus subtitle data linked to the clips.

50. The information storage medium of claim 49, further comprising an address of a site on the Internet when the indication information is stored at the site.

51. The information storage medium of claim 49, further comprising information regarding a location of a portion of the information storage medium when the indication information is stored in the portion.

52. The information storage medium of claim 48, wherein the subtitle and video mapping information comprises language information regarding languages of the subtitle data.

53. The information storage medium of claim 48, wherein the subtitle and video mapping information comprises title indication information regarding titles of the subtitle data displayed on a screen.

54. The information storage medium of claim 48, wherein the subtitle and video mapping information comprises text-based subtitle data information related to the video data.

55. The information storage medium of claim 54, wherein the subtitle data information further comprises synchronization time information indicating to the apparatus relative time information regarding a point of time of reproducing the clips.

56. The information storage medium of claim 54, wherein the subtitle and video mapping information and the text-based subtitle data information are separately recorded in units of files or units of information storage units.

57. An information storage medium in which multi-story data is recorded to have multiple paths for reproduction by a recording and/or reproducing apparatus in units of clips according to a Blu-ray video structure, comprising:
multi-lingual subtitle indication information supporting multiple languages;
text-based data information; and
subtitle and video mapping information specifying to the apparatus a linkage relation between the subtitles including the text based data information for each of the multiple languages and a series of video data according to the multiple paths for reproduction by the apparatus.

58. The information storage medium of claim 57, wherein the apparatus retrieves the indication information from an address of a site on the Internet when the multi-lingual subtitle indication information is stored at the site.

59. The information storage medium of claim 57, further comprising information regarding a location of a portion of the information storage medium when the multi-lingual subtitle indication information is stored in the portion.

60. The information storage medium of claim 57, wherein the multi-lingual subtitle indication information comprises indication information indicating subtitle data linked to the clips.

61. The information storage medium of claim 57, wherein the multi-lingual subtitle indication information comprises indication information regarding languages of the subtitle and video mapping information.

62. The information storage medium of claim 57, wherein the multi-lingual subtitle indication information comprises title indication information regarding titles of the subtitle and video mapping information displayed on a screen.

63. The information storage medium of claim 57, wherein the subtitle and video mapping information comprises subtitle language information regarding subtitle languages, title indication information regarding titles of the subtitle data displayed on the screen, and subtitle location indication information regarding locations of the subtitle data.

64. The information storage medium of claim 57, wherein the subtitle data information further comprises synchronization time information indicating to the apparatus relative time information regarding a point of time of reproducing the clips.

65. The information storage medium of claim 57, wherein the multi-lingual subtitle indication information, the subtitle data information, and the subtitle and video mapping information are separately recorded in units of files or units of information storage units.

66. The information storage medium of claim 57, wherein the multi-lingual subtitle indication information, the subtitle data information, and the subtitle and video mapping information are combined and recorded in the same area.

67. An apparatus for recording and/or reproducing multi-story video data recorded to have multiple paths for reproduction from an information storage medium, the apparatus comprising:
a reader which reads audio/video (AV) data having the multi-story video data, and subtitle and video mapping information including text-based subtitle data, multi-lingual subtitle indication information, and/or downloaded font data indicated in the subtitle and video mapping information from the information storage medium;
a decoder which decodes the AV data;
a subtitle processor which processes a language selection file related to the subtitle data and the subtitle and video mapping information and performs screen rendering; and
a blender which combines a moving image output from the decoder for a selected one of the stories and the subtitle data output from the subtitle processor and outputs a result of combination to be displayed on a display device.

68. The apparatus of claim 67, further comprising:
a buffer which buffers data exchanged among the reader, the decoder, and the subtitle processor, and storing determined font data; and
a storage unit which stores resident font data stored as a default.

69. The apparatus of claim 67, wherein the multi-story video data is recorded based on a structure of DVD-video data.

70. The apparatus of claim 67, wherein the multi-story video data is recorded based on a structure of Blu-ray video data.

71. The apparatus of claim 67, wherein when the multi-lingual subtitle indication information is stored in a site on the Internet, the information storage medium further comprises an address of the site.

72. The apparatus of claim 67, wherein when the multi-lingual subtitle indication information is stored in a portion of the information storage medium the information storage medium further comprises, information regarding location of the portion.

73. The apparatus of claim 67, wherein the multi-lingual subtitle indication information, the subtitle data information, and the subtitle and video mapping information are separately recorded in units of files or units of information storage units.

74. The apparatus of claim 67, wherein the multi-lingual subtitle indication information, the subtitle data information, and the subtitle and video mapping information are combined and recorded in the same area.

75. A method of reproducing multi-story video data recorded to have multiple paths for reproduction from an information storage medium, the method comprising:
determining a subtitle language and detecting a location of subtitle and video mapping information that specifies a linkage relation between text-based subtitles and a series of video data;
reading and parsing the subtitle and video mapping information, and reading subtitle data related to a portion of the video data that is to be reproduced; and
reproducing the subtitle data to correspond to the reproduced portion of the video data.

76. The method of claim 75, wherein the subtitle language is determined as set in a reproducing apparatus or from a menu stored in the information storage medium during reproduction of the multi-story video data from the information storage medium.

77. The method of claim 75, wherein the subtitle language is determined by reading multi-lingual subtitle indication information from the information storage medium or at an address of a site on the Internet such as a uniform resource identifier, information of the address being obtained by the reproducing apparatus during reproduction of the multi-story video data; and selecting one from languages specified in the multi-lingual subtitle indication information based on information regarding the language set by a user or set in the reproducing apparatus.

78. The method of claim 77, wherein the reading of the multi-lingual subtitle indication information comprises:
reading subtitle and video mapping data related to the subtitle language in the reproducing apparatus from multi-lingual subtitle indication information corresponding to the subtitle language; and
parsing the subtitle and video mapping information and reading subtitle data for video data that is to be reproduced.

79. A method of reproducing multi-story data recorded to have multiple paths for reproduction and according to a DVD-video structure from an information storage medium, the method comprising:
determining a subtitle language and detecting a location of subtitle and video mapping information regarding a linkage relation between text-based subtitles and a series of video data;
reading and parsing the subtitle and video mapping information, and reading subtitle data for a portion of the video data that is to be reproduced; and
reproducing the subtitle data to correspond to the reproduced portion of the video data to be displayed on a screen.

80. The method of claim 79, wherein the subtitle language is determined as set in a reproducing apparatus or from a menu stored in the information storage medium during reproduction of the multi-story video data.

81. The method of claim 79, wherein the subtitle language is determined by:
reading multi-lingual subtitle indication information from the information storage medium or at an address of a site on the Internet such as a uniform resource identifier, information of the address being obtained by the reproducing apparatus during reproduction of the multi-story video data; and
selecting one from languages specified in the multi-lingual subtitle indication information based on information regarding the language set by a user or set in the reproducing apparatus.

82. The method of claim 79, wherein the reading of the subtitle data comprises:
reading subtitle and video mapping information related to the subtitle language in the reproducing apparatus from multi-lingual subtitle indication information corresponding to the determined subtitle language; and
parsing the read subtitle and video mapping information; determining whether the video data that is to be reproduced is video manager information for a menu linked to a video object set, a video title set for a menu linked to a video object set, or a video title set for a title linked to a video object set, and reading subtitle data related to the video data.

83. The method of claim 79, wherein during the reproducing of the subtitle data, data search information is detected from a navigation pack of a video object unit where reproduction of the video data starts, the subtitle data related to the video data displayed on a screen is detected, the reproduction of the video data starts together with reproduction of the subtitle data, and the other subtitle data for the other video data are detected and output to correspond to the video data reproduced.

84. A method of reproducing multi-story video data recorded to have with multiple paths for reproduction in units of clips from an information storage medium, the method comprising:
determining a subtitle language and detecting a location of subtitle and video mapping information regarding a linkage relation between text-based subtitles and a series of video data;
reading and parsing the subtitle and video mapping information, and reading subtitle data for a portion of the video data that is to be reproduced; and
reproducing the subtitle data to correspond to the reproduced portion of the video data being displayed on a screen.

85. The method of claim 84, wherein the subtitle language is determined as set in a reproducing apparatus or from a menu stored in the information storage medium during reproduction of the multi-story video data.

86. The method of claim 84, wherein the subtitle language is determined by:
reading multi-lingual subtitle indication information from the information storage medium or at an address of a site on the Internet such as a uniform resource identifier, information of the address being obtained by a reproducing apparatus during reproduction of the multi-story video data; and
selecting one from languages specified in the multi-lingual subtitle indication information based on information regarding the language set by a user or set in the reproducing apparatus.

87. The method of claim 84, wherein the reading of the subtitle data comprises:
reading subtitle and video mapping information related to the subtitle language in the reproducing apparatus from multi-lingual subtitle indication information corresponding to the determined subtitle language; and
parsing the read subtitle and video mapping information, determining a clip to which the video data that is to be reproduced is linked, and reading subtitle data linked to the clip.

88. The method of claim 84, wherein during the reproducing of the subtitle data, information regarding a clip where reproduction of the video data starts is detected, subtitle data matching reproduction time of the clip is detected, the reproduction of the video data starts together with reproduction of the subtitle data, and the other subtitle data for the other video data are detected and output to correspond to the video data reproduced.
